(19) United States
(12) Patent Application Publication
(10) Pub. No.: US 2015/0073850 A1
(43) Pub. Date: Mar. 12, 2015

(54) Assessing Staffing Coverage for Software Applications

(71) Applicant: Bank of America Corporation, Charlotte, NC (US)

(72) Inventors: Brian Max Kale, Henderson, NV (US); Sanjay Sudhirkumar Dhulia, Andhra Pradesh (IN)

(21) Appl. No.: 14/540,344

(22) Filed: Nov. 13, 2014

Related U.S. Application Data
(63) Continuation of application No. 12/797,186, filed on Jun. 9, 2010.

(51) Int. Cl. G06Q 10/06

(52) U.S. Cl. CPC G06Q 10/063116
USPC 705/7.16

(57) ABSTRACT

A computer system enables a business to determine a structure of a software application, obtain staffing information assigned to the application, and determine a staffing gap for different levels of the application. Staffing assessment may be expanded to a software portfolio that typically includes different applications and further to a line of business segment that corresponds to one or more portfolios. Supply coverage and demand coverage for each of the application levels is then determined so that staffing gaps for each of the application levels can be assessed. Staffing information may include staffing at different skill levels include subject matter experts, specialists, and generalists. The structure of an application may include modules that further include sub-modules. A training plan may be invoked when staffing is overly dependent on contractor support.

### CROSS-REFERENCE TO RELATED APPLICATION

This application is a continuation of U.S. application Ser. No. 12/797,186 filed on Jun. 9, 2010, entitled “Assessing Staffing Coverage for Software Applications,” which is incorporated herein by reference in its entirety.

### FIELD

The invention relates generally to computer systems and associated software. Aspects of the embodiments relate to a computer system that determines gaps in staffing a project with workers having a desired skill level.

### BACKGROUND

A subject matter expert (SME) is a person who is an expert in a particular area or topic. In software engineering environments, the term is often used to describe professionals with expertise in the field of an application but may have a broader definition in engineering and high tech as one who has the greatest expertise in a technical topic. SMEs may be asked to review, improve, and approve technical work, to guide others, and to teach. According to Six Sigma, a SME “exhibits the highest level of expertise in performing a specialized job, task, or skill.”

With the development of complex computer systems (e.g., artificial intelligence, expert systems, control, simulation, or business software), a SME is typically a person who is knowledgeable about the domain being represented. The SME often tells software developers what needs to be done by the computer system, and how the SME intends to use it. The SME may interact directly with the system, possibly through a simplified interface or may codify domain knowledge for use by knowledge engineers or ontologists and may also be involved in validating the resulting system.

SMEs are often vital to the success of developing and maintaining software projects. Consequently, projects should be properly staffed with people who have a sufficient degree of knowledge in the specific areas spanned by the software project. It may be difficult to keep projects on schedule and on budget when developers cannot get information when it is needed. SMEs typically have special, in-depth knowledge of one or more business areas. This critical knowledge, when shared with others, can significantly elevate performance within the organization.

### BRIEF SUMMARY

Aspects of the embodiments address one or more of the issues mentioned above by disclosing methods, computer readable media, and apparatuses to determine a structure of a software application, obtain staffing information assigned to the application, and determine a staffing gap for different levels of the application. A staffing assessment may be expanded to a software portfolio that typically comprises different applications and further to a line of business (LOB) segment that corresponds to one or more portfolios.

With another aspect of the embodiments, a structure of a software application is determined and corresponding staffing information is obtained. Supply coverage and demand coverage for each of the application levels is determined so that staffing gaps for each of the application levels can be assessed. Staffing information may include staffing at different skill levels include subject matter experts (SMEs), specialists, and generalists.

With another aspect of the embodiments, the structure of an application may include modules that further comprise sub-modules. Applications may be organized into a portfolio, and one or more portfolios may be associated with a line of business segment.

With another aspect of the embodiments, subject matter experts are classified as business associates or contractors. Metrics may be supported based on overall staffing coverage, associate staffing coverage, and contractor staffing coverage for different components of an application. A training plan may be invoked when staffing is overly dependent on contractor support.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the embodiments.

FIG. 3 shows a relationship among portfolios, applications, modules, and sub-modules in accordance with an aspect of the embodiments.

FIG. 4 shows a flow diagram to assess whether there are gaps in staffing for supporting an application in accordance with an aspect of the embodiments.

FIG. 5 shows a flow diagram for obtaining staffing information in accordance with an aspect of the embodiments.

FIG. 6 shows processes involved in collecting and mapping SME staffing information, analyzing gaps, and defining plan to develop and bridge SME gaps in accordance with an aspect of the embodiments.

FIG. 7 shows a flow diagram depicting the controls put in place to authenticate the user and provide access to view specific information when access is authorized in accordance with an aspect of the embodiments.

FIG. 8 shows a flow diagram for calculating the count of SMEs defining a pyramid by means of generalist, specialist and expert in accordance with an aspect of the embodiments.

FIG. 9 shows a flow diagram to calculate a SME metric, SME demand coverage and to measure performance against a threshold in accordance with an aspect of the embodiments.

FIG. 10 shows s flow diagram to calculate a SME metric, associate SME coverage and to measure performance against a threshold in accordance with an aspect of the embodiments.

FIG. 11 shows a flow diagram of user interaction to manage application portfolios in accordance with an aspect of the embodiments.

FIGS. 12 and 13 show a flow diagram for user interaction to manage applications in accordance with an aspect of the embodiments.

FIG. 14 shows the flow diagram for user interaction to obtain/provide staffing information in accordance with an aspect of the embodiments.

FIG. 15 shows a flow diagram to fill the gaps in staffing for supporting an application in accordance with an aspect of the embodiments.

FIG. 16 shows an illustrative screenshot of a home page depicting SME staffing for a business in accordance with an aspect of the embodiments.

FIG. 17 shows an illustrative screenshot depicting SME staffing for a line of business segment in accordance with an aspect of the embodiments.

FIG. 18 shows an illustrative screenshot depicting SME staffing for different levels of an application in accordance with an aspect of the embodiments.

FIG. 19 shows a block diagram of a system that assesses SME staffing in accordance with an aspect of the embodiments.

FIG. 20 shows a process that assesses SME staffing in accordance with an aspect of the embodiments.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

In the description herein, the following terms are referenced.

Application: An application refers to a software application that is stand-alone grouping of functions. An application may be an automated representation of one or more business processes.

Associate: An associate is an employee of a business entity

Contractor: A contractor works for a business entity in accordance with a contract. The contractor may be an employee of a different business entity (i.e., third party).

Expert: An expert is a person who has a deep technology knowledge as well as understanding of the underlying business process. An expert may be referred to as a subject matter expert (SME) for a corresponding software program (e.g., application, module, and sub-module).

Generalist: A generalist has a broad understanding of a software program such as an application. A generalist typically has application specific techno-functional skills, is able to work independently, and is able to improve the overall quality of deliverables.

Module: A module is a software program that supports a function. Functions are typically logically grouped together to form an application. As an example, a word processor may include a spell check function.

Process: A process refers to a business process that comprises a series of actions to achieve a business task. A process is often technology-independent and may be implemented with one of a plurality of computer programming languages.

Portfolio: A portfolio is a logical group of applications.

Specialist: A specialist has a deep functional understanding knowledge of a software program and is able to provide direction to a specific functional area. A specialist typically can contribute to all phases and deliverables of application work products, can lead and manage projects/initiatives, process improvements, support improved decision making, and provide mentoring/training.

Sub-module: A sub-module is a software program that supports portions of a function. Consequently, a module is typically associated with a plurality of sub-modules.

In accordance with various aspects of the embodiments, methods, computer-readable media, and apparatuses are disclosed to determine a structure of a software application, obtain staffing information assigned to the application, and determine a staffing gap for different levels of the application. Staffing assessment may be expanded to a software portfolio that typically comprises different applications and further to a line of business (LOB) segment that corresponds to one or more portfolios.

With traditional systems, a manager may gauge the staffing gap for an application by a broad assessment of the application without systematically considering staffing needs at different levels of the application. According to aspects described herein, the staffing gap of the application is determined from the staffing demand and staffing coverage for the different modules and sub-modules associated with the application.

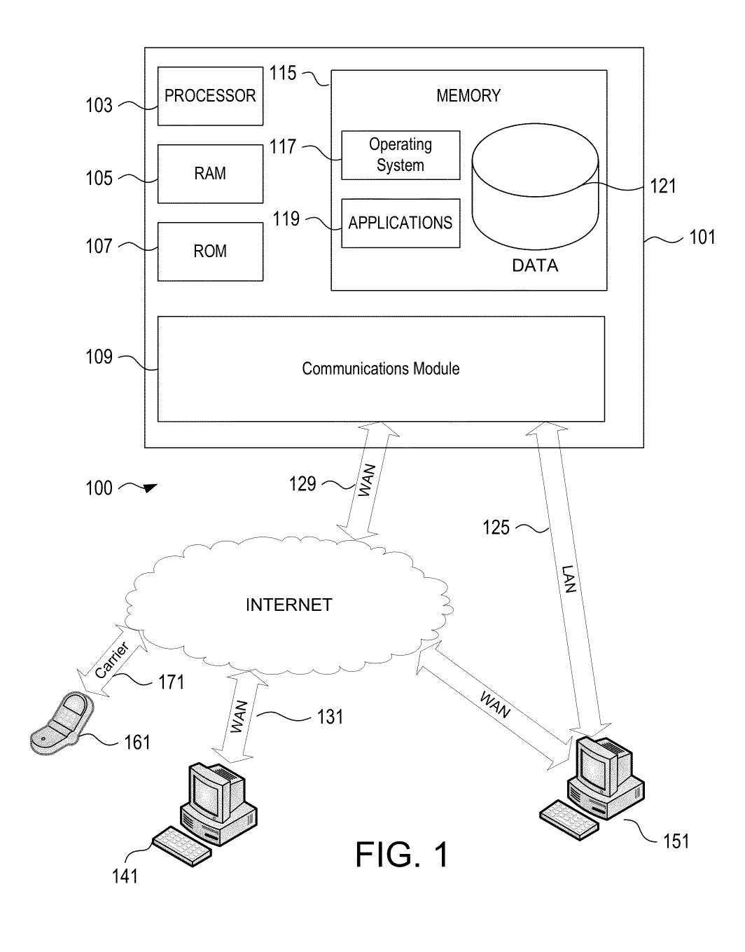

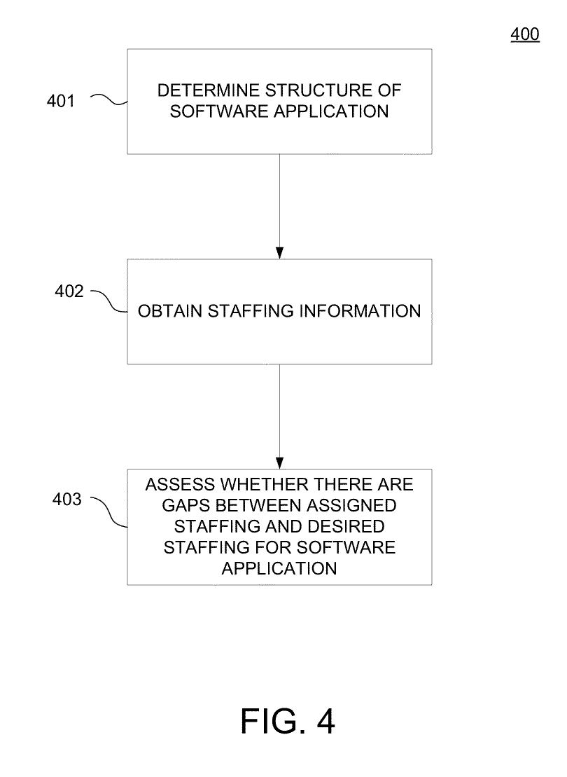

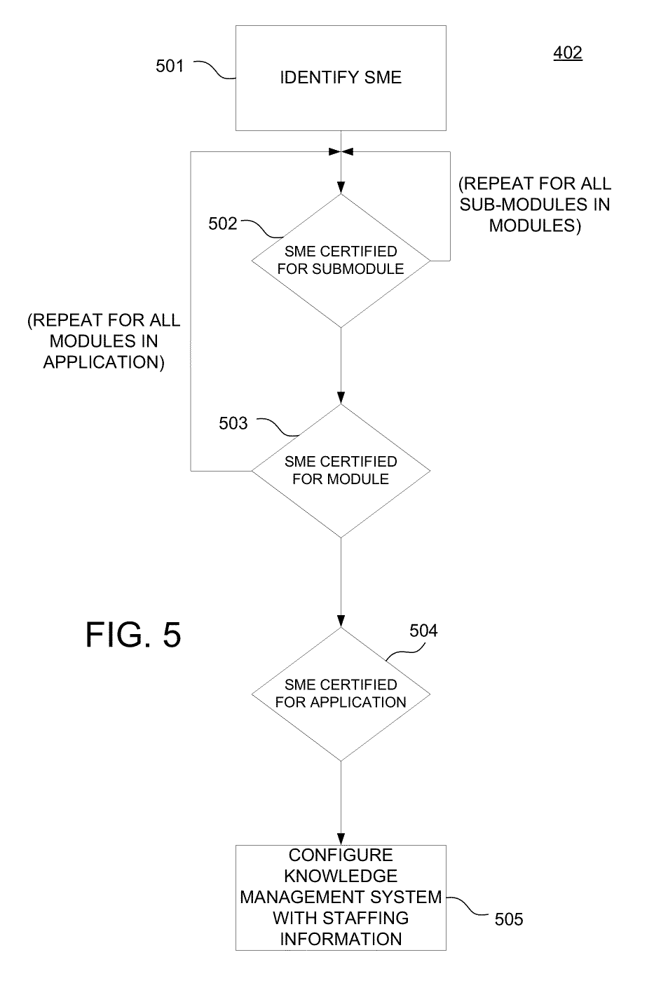

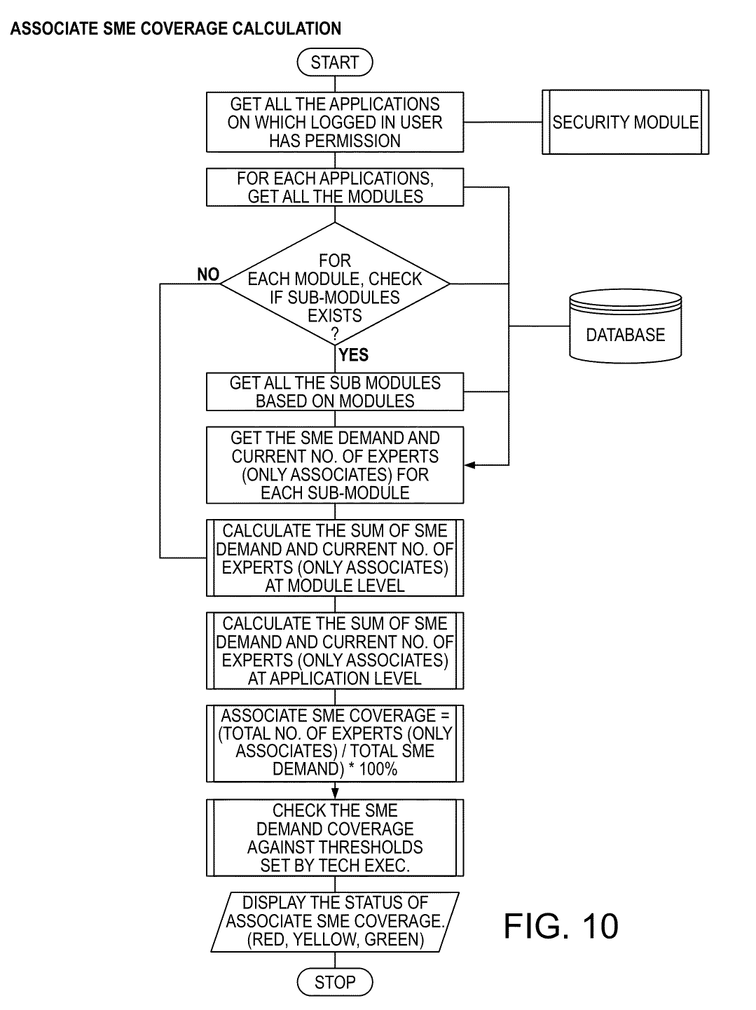

FIG. 1 illustrates an example of a suitable computing system environment 100 (e.g., for process 400 as shown in FIGS. 4 and 5 and process 1000 as shown in FIG. 10) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Illustrative usages include scanning and converting paper documents, e.g., correspondence and receipts to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

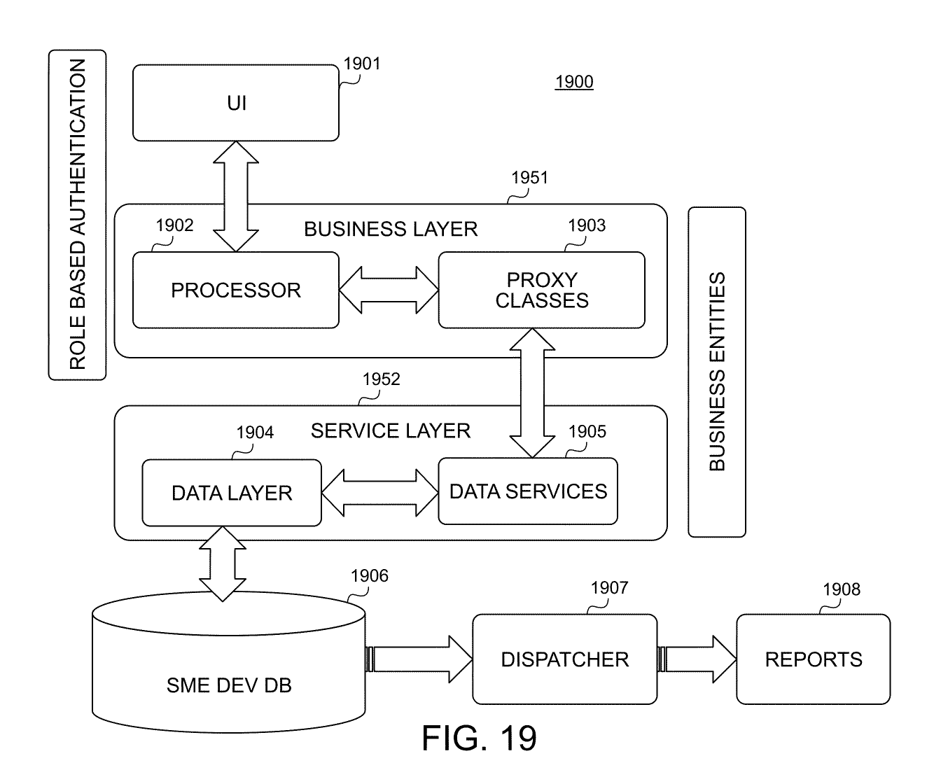

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of SME staffing information (e.g., SME development database 1906 as shown in FIG. 19) that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking functionality related to businesses processes such as dispute resolution for customers. Other application programs may support user functionality 119, including email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

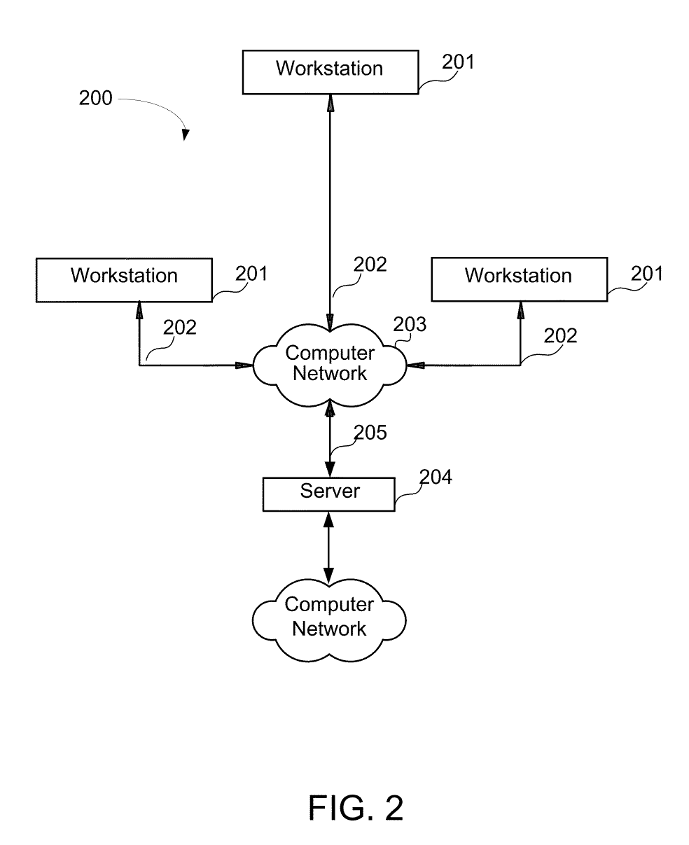

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links. Connectivity may also be supported to a CCTV or image/iris capturing device.

The steps that follow in the Figures may be implemented by one or more of the components in FIGS. 1 and 2 and/or other components, including other computing devices.

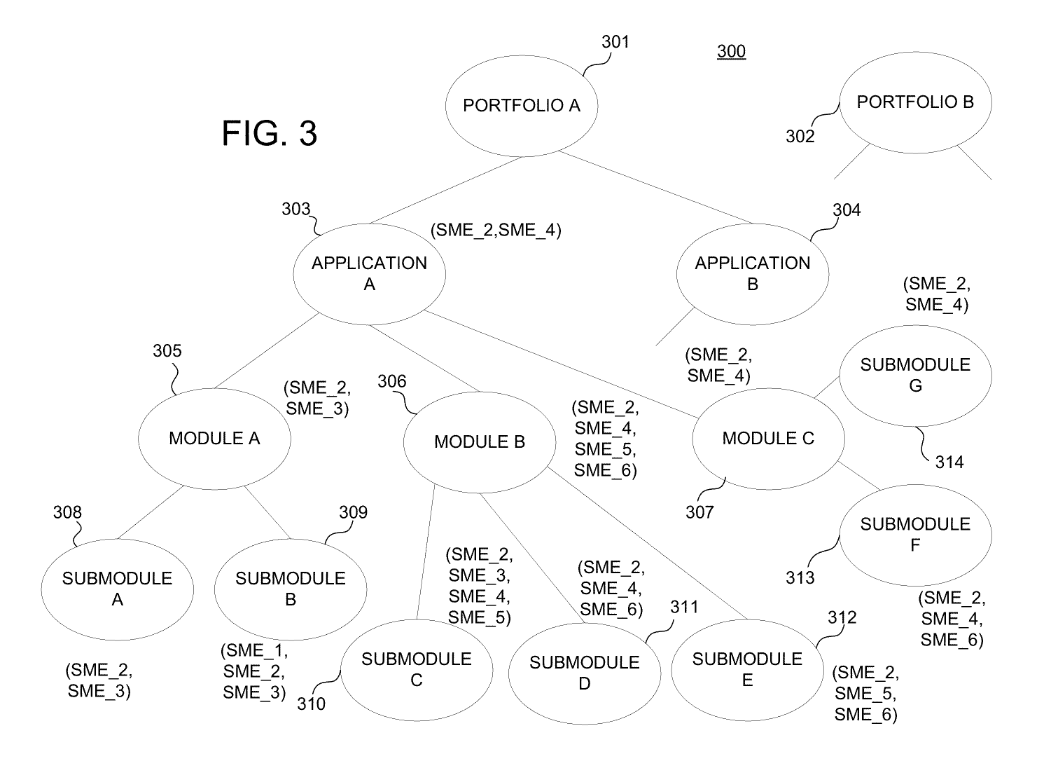

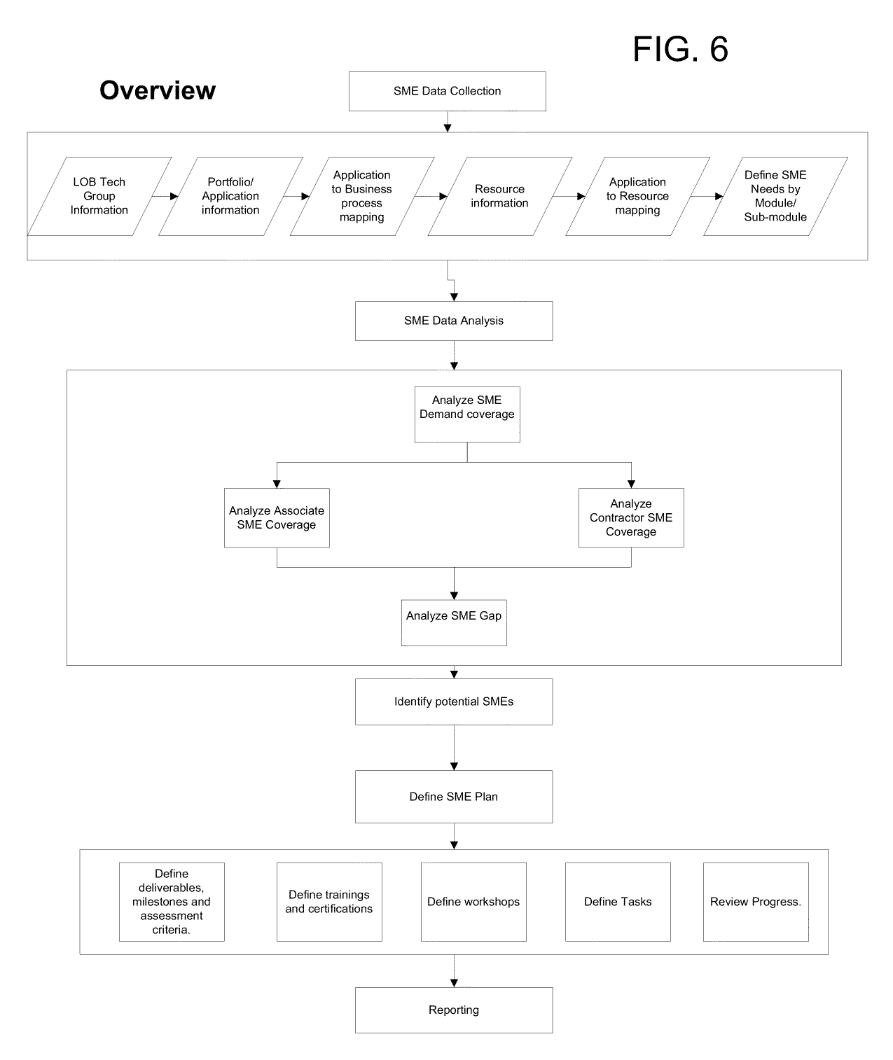

FIG. 3 shows line of business 300 that includes portfolios 301-302, applications 303-304, modules 305-307, and sub-modules 308-314 in accordance with an aspect of the embodiments. Line of business segment 300 may encompass different portfolios 301-302 (corresponding to consolidated superstation technology 604 and internal business system 605 as shown in FIG. 6). Portfolio 301 includes different applications 303-304, where an application typically is a stand-alone grouping of modules 305-306. Each module typically corresponds to a business process (function), and each module typically includes different sub-modules, where each sub-module executes a portion of the business process. For example, charge back and assessing a customer's ability to pay are business processes that are associated with dispute resolution.

FIG. 3 also shows staffing assigned to different levels of application 303, including sub-modules 308-314, modules 305-307, and application 303. “SME_x” depicts the x^{th} subject matter expert (SME) that is certified for a sub-module, module, or application. Embodiments may utilize different approaches to certification, including gauging an employee's depth of experience by testing or performance review. In the example shown in FIG. 3, a SME is considered certified at a higher level (e.g., module level) if the SME is certified for a majority of components at a lower level (e.g., sub-module level). However, some embodiments may utilize a different percentage (e.g., 80%) of components at a lower level when determining whether a SME is certified at a higher level.

With some embodiments, certification at the application level is determined by a percentage expert level coverage of the sub-modules for the application.

While the x^{th} SME corresponds to a worker (either an associate of the business or a contractor), the x^{th} SME may be associated with a plurality of components for the application. Consequently, the SME coverage typically exceeds the number of SMEs.

Staffing may be categorized at different skill levels. For example, an “expert” (SME) may be differentiated as having role deep technology knowledge for a domain and business, taking decisions and accountability, working independently with line of business and cross functionality teams, and serving as single point of contact for applications and business processes. A “specialist” may have a deep functional knowledge providing direction to specific functional area, contribute to all phases and deliverables of application work products, lead and manage projects, initiatives, and process improvements, improve decision making, mentor, and train other employees. A “generalist” may be characterized by increasing his/her breadth of knowledge to improve overall quality of deliverables, understanding application-specific techno-functional skills, being able to work independently, and improving the overall quality of deliverables. An employee often progresses upward through the skill levels from a generalist to a specialist to an expert with work experience and training. However, a business may directly hire a SME (e.g., a contractor) to help rectify a staffing gap.

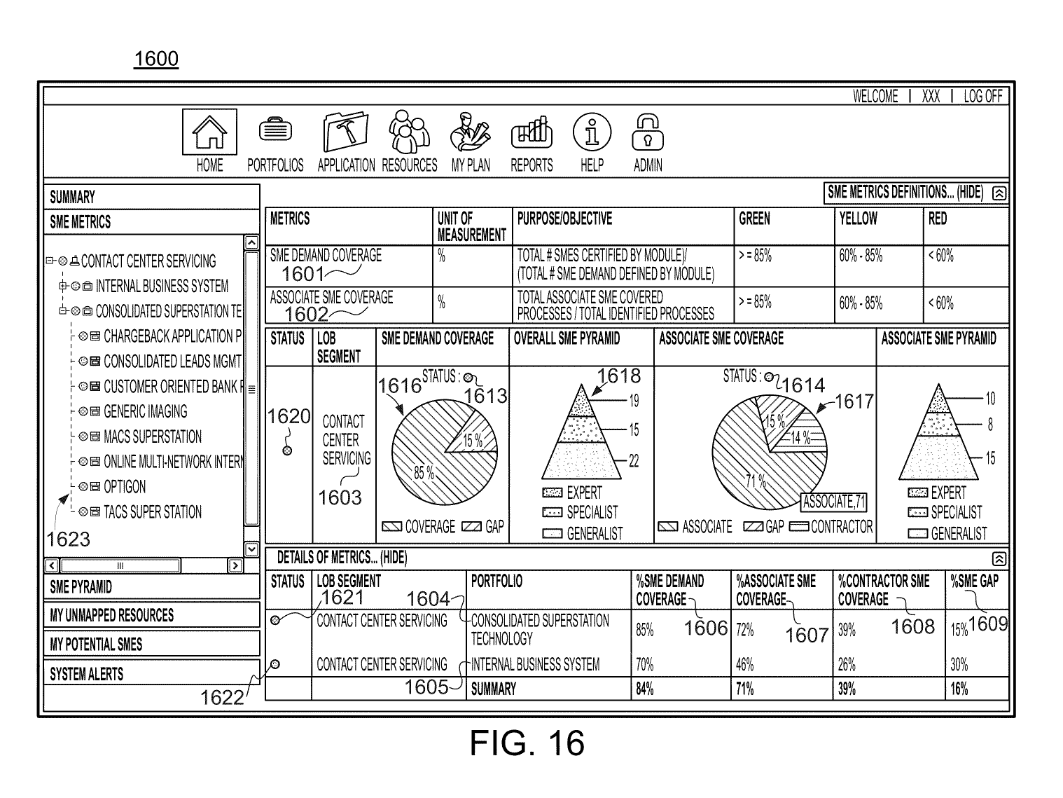

While FIG. 3 shows staffing for experts, some embodiments may show staffing for different skill levels (e.g., specialist or generalist) or for a combination of skill levels. While some embodiments (e.g., as shown in FIGS. 16-18) determine supply coverage and demand coverage for SMEs of each application level, other embodiments may assess staffing for other skill levels.

FIG. 4 shows flow diagram 400 to assess whether there are gaps in staffing for supporting an application in accordance with an aspect of the embodiments. At block 401, the software structure of an application is determined. For example, modules and sub-modules are mapped to a given application (e.g., modules 305-307 and sub-modules 308-314 as shown in FIG. 3). At step 402, staffing information is obtained based on the structure of the application. For example, SME supply coverage and SME demand coverage for each module and associated sub-module are determined. Staffing gaps at each application level may be determined from the supply coverage and demand coverage at block 403. For example, the SME supply coverage may be subtracted from the SME demand coverage for each component of the application to assess staffing gaps for the application.

With some embodiments, computer system 100 determines whether there is a dependency upon contractors as experts (SMEs) that may result in an organizational risk for loss of knowledge. In addition, system 100 may calculate the level of SME penetration by location such as US, India, UK, and so forth. Also, system 100 may identify potential resources that may be considered for maturing into “expert” (SME) role. System 100 may also maintain history of the resources proficiency level even when the resources move from one application to other. This capability may track the span of knowledge of individuals across application and portfolios.

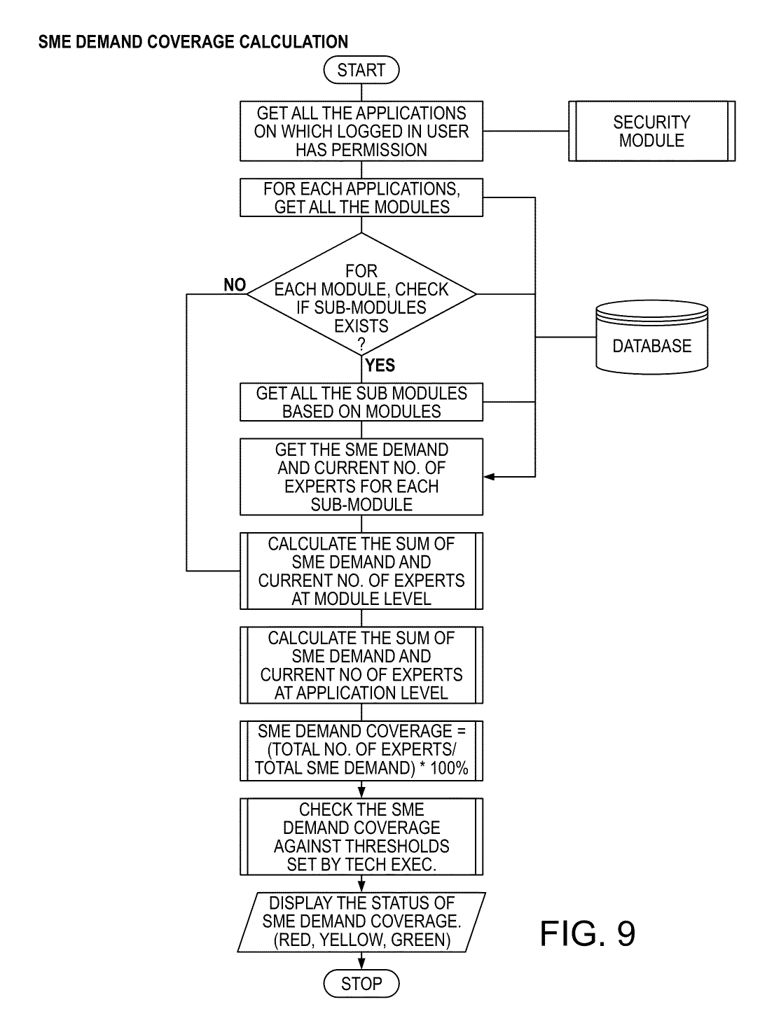

With some embodiments, flow diagram 400 may be executed by computer system 100. For example, staffing information for application programs 119 may be obtained through communications module 109 (as shown in FIG. 1) or from user interface 901 (as shown in FIG. 9). Computer system 100 may then process the staffing information to assess whether there are any gaps for the different components of application programs 119.

FIG. 5 shows flow diagram 402 for obtaining staffing information for an application in accordance with an aspect of the embodiments. At block 501, a worker is identified as a SME. The worker may be an employee (associate) of the business or a contractor. At block 502, process 402 determines whether the SME is certified for one of the sub-modules of a module and repeats the processing for the other sub-modules of the module. If the SME is certified for a predetermined percentage of sub-modules, then the SME is determined to be certified for the module at block 503. If there are additional modules associated with the application, then blocks 502 and 503 are repeated.

At block 504, process 402 determines whether the SME is certified for the application. For example, the SME may be certified at the application level when the SME is certified for a predetermined percentage of modules. At block 505, process 402 updates a knowledge management system with the determined staffing information and repeats blocks 501-505 for another SME.

With an aspect of the embodiments, multiple risks are addressed by relating the ability of a business to manage and develop SMEs for applications. A perceived risk of insufficient SME support may lead to application stability issue or a bottleneck for change. Also, a large population of contractor of SMEs may result in a risk of co-employment or a loss of institutional knowledge. Developing associates within the business rather depending on contractors may provide increased stability so that cross-training opportunities may be formalized.

With another aspect of the embodiments, a data repository for SME staffing with relevant metrics (e.g., as described in the table below) is supported. A measurement system is provided to baseline and track SME coverage. Targets may be set and the progress of countermeasures against those targets may be tracked.

The above aspects may provide benefits to a business including talent development and retention, increased depth and breadth of knowledge, efficient knowledge management, improved decision making, enablement of local governance and oversight, and the avoidance of single point knowledge failure. Also, the above aspects may improve overall organization efficiency and performance, enhance strategies, enhance the business value of technology, enable job rotation, retain and develop talent, and stimulate and motivate associates.

FIG. 6 shows processes involved in collecting and mapping SME staffing information, analyzing gaps, and defining plan to develop and bridge SME gaps in accordance with an aspect of the embodiments.

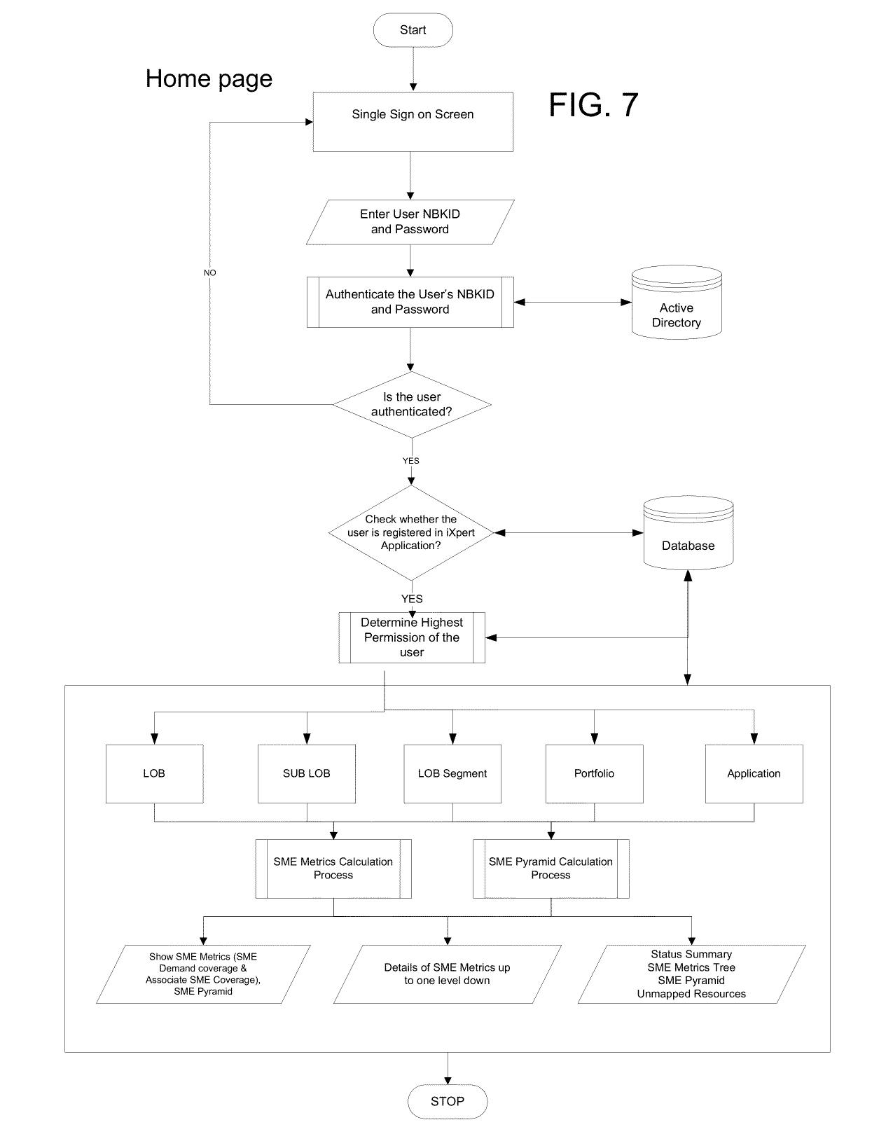

FIG. 7 shows a flow diagram depicting the controls put in place to authenticate the user and provide access to view specific information when access is authorized in accordance with an aspect of the embodiments.

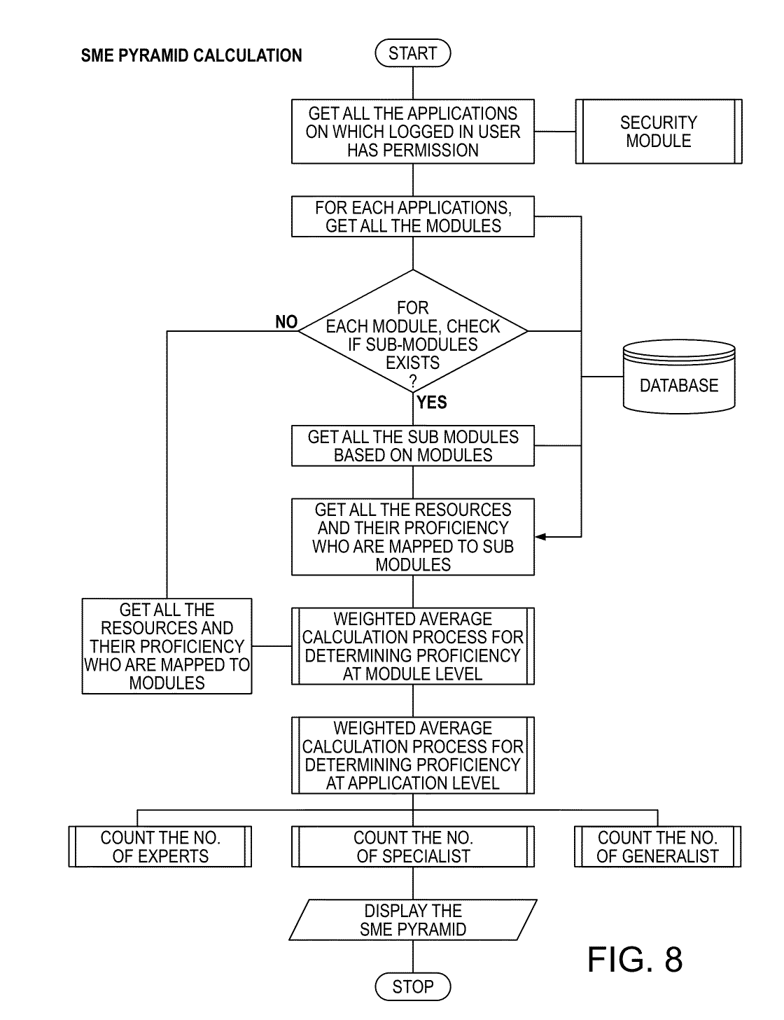

FIG. 8 shows a flow diagram for calculating the count of SMEs defining a pyramid by means of generalist, specialist and expert in accordance with an aspect of the embodiments.

FIG. 9 shows a flow diagram to calculate a SME metric, SME demand coverage and to measure performance against a threshold in accordance with an aspect of the embodiments.

FIG. 10 shows a flow diagram to calculate a SME metric, associate SME coverage and to measure performance against a threshold in accordance with an aspect of the embodiments.

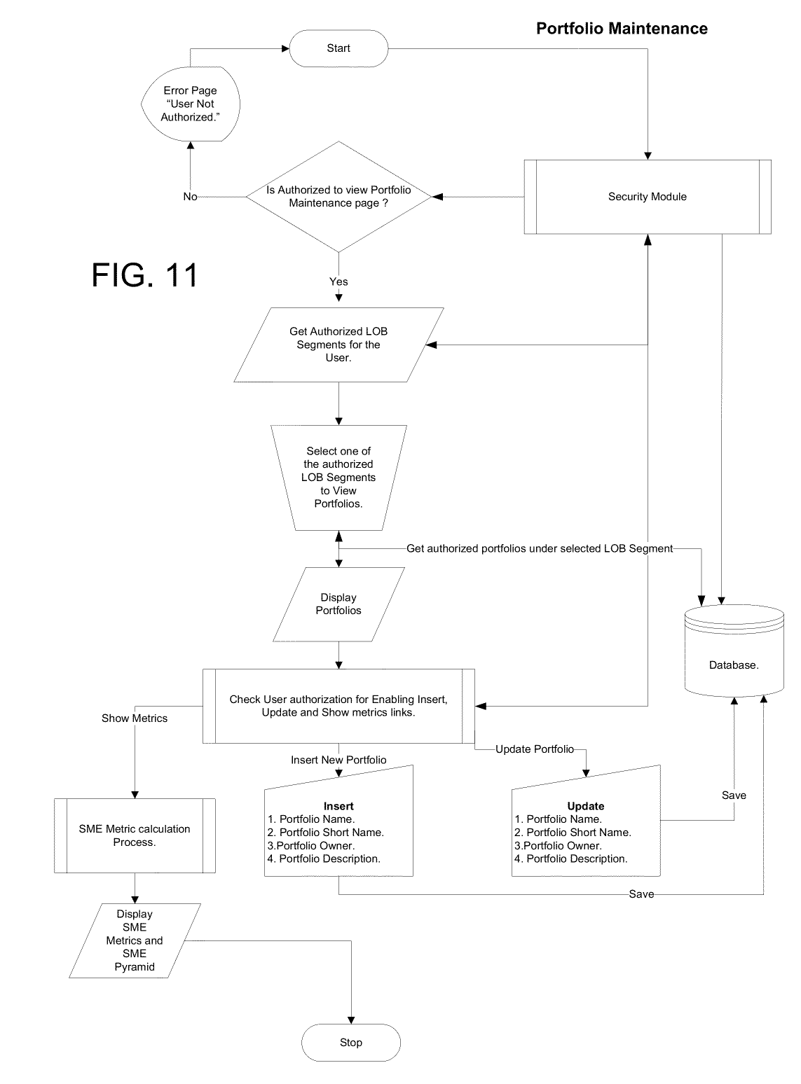

FIG. 11 shows a flow diagram for user interaction to manage application portfolios in accordance with an aspect of the embodiments.

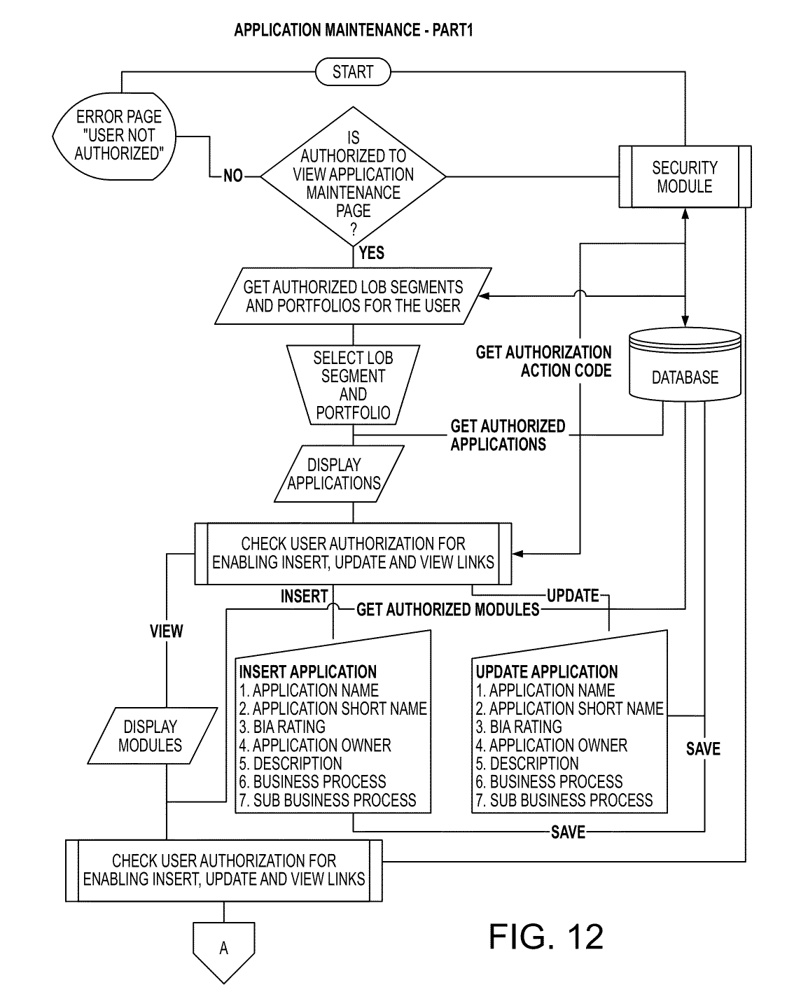

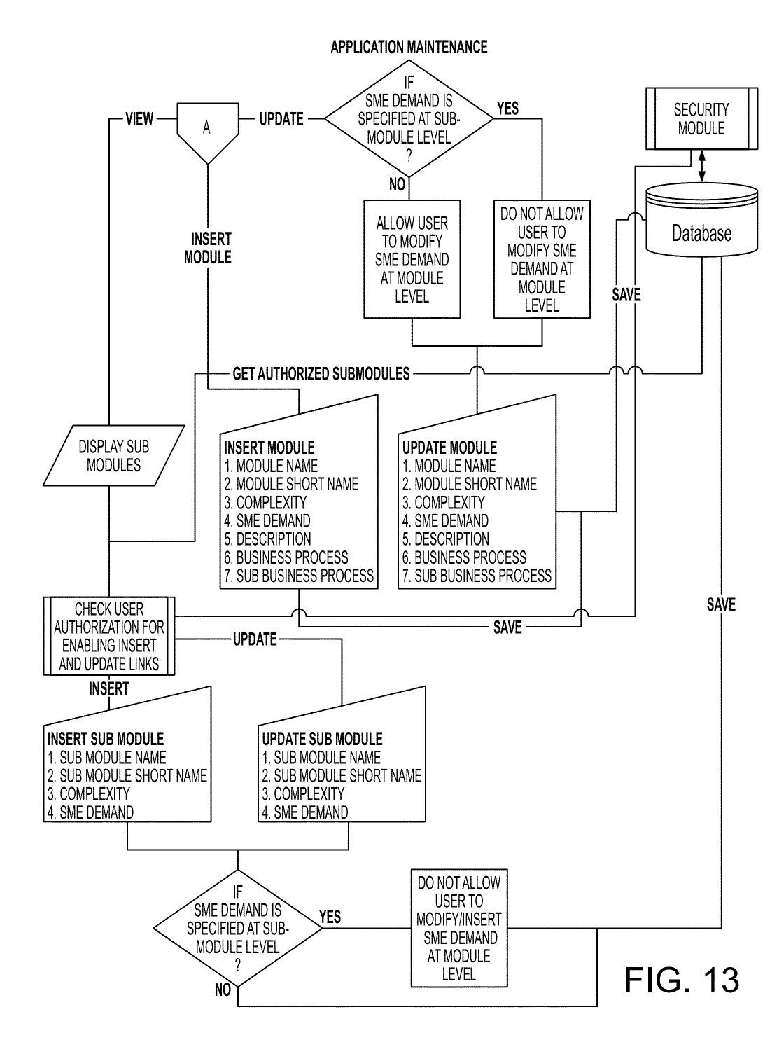

FIGS. 12 and 13 show a flow diagram for user interaction to manage applications in accordance with an aspect of the embodiments.

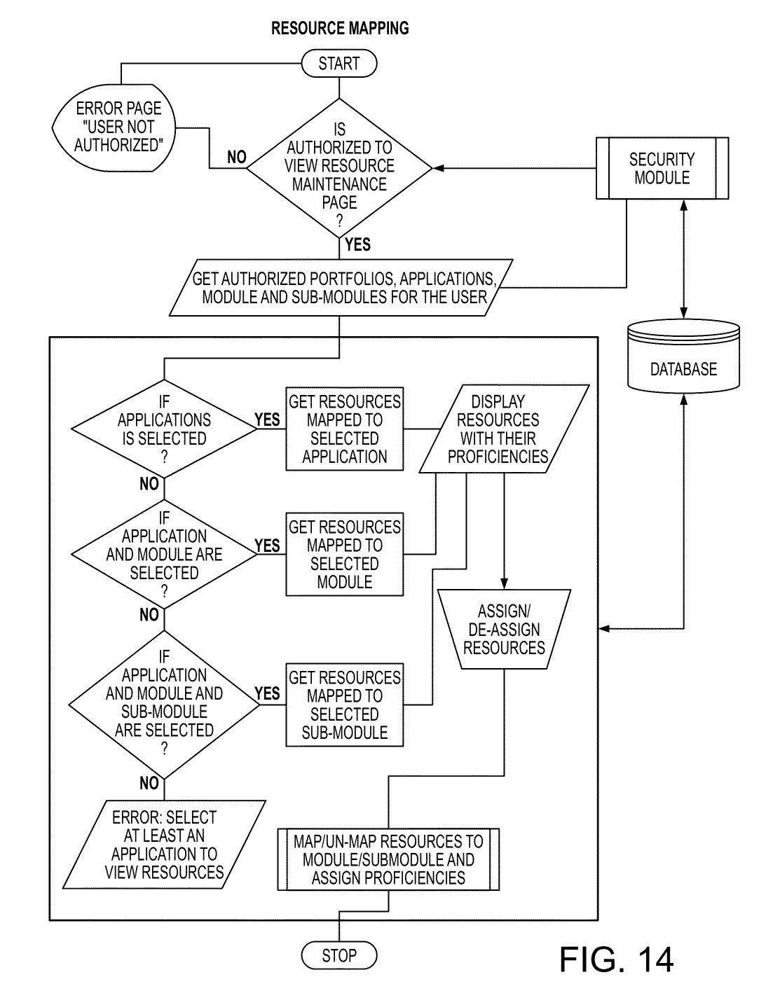

FIG. 14 shows the flow diagram for user interaction to obtain/provide staffing information in accordance with an aspect of the embodiments.

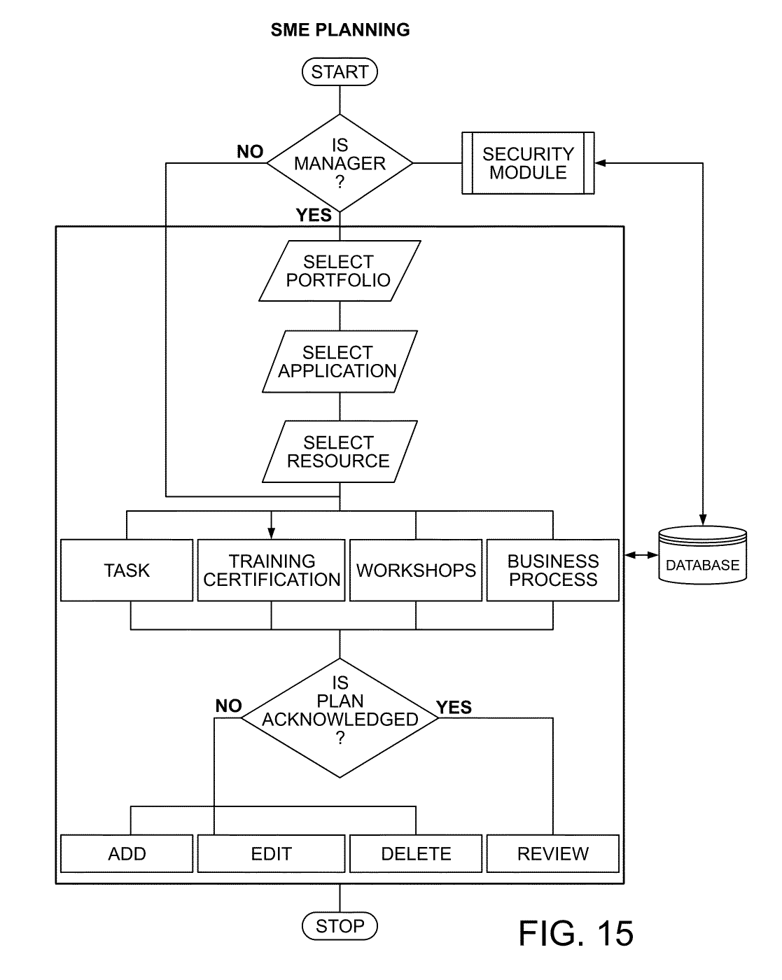

FIG. 15 shows a flow diagram to fill the gaps in staffing for supporting an application in accordance with an aspect of the embodiments.

FIG. 16 shows illustrative screenshot 1600 of a home page depicting SME staffing for a business in accordance with an aspect of the embodiments. Screenshot 1600 may be displayed when the user signs in into the system 100. Based on the primary role of the stakeholder, key SME metrics and SME pyramids are shown. The user can drill down to see the SME metrics and pyramid to the application level using the tree view shown in left pane 1623.

Screenshot 1600 provides a staffing assessment at the LOB segment (contact center servicing 1603); however, other embodiments may provide a staffing assessment at different business levels.

TABLE 1
TABLE: MEASUREMENT METRICS

| | | | |
|---|---|---|---|
| SME Demand | % | Identify the | (Total # SMEs certified |
| Coverage | | coverage of | by module)/(Total |
| | | resources of the | # SME demand |
| | | defined demand | defined by module) |
| Associate SME | % | Identify # of | Total Associate SME |
| Coverage | | Processes | Covered Processes/Total |
| | | supported by | Identified Processes |
| | | Associate SMEs | |
| Contractor SME | % | Identify # of | Total Contractor SME |
| Coverage | | Processes | Covered Processes/Total |
| | | Supported by | Identified Processes |
| | | Contractor SMEs | |
| SME Gap | % | Identify the Gap | Total Processes Planned |
| Mitigation | | in terms of | (Associates) for |
| Coverage | | Processes covered | Contractor SME Covered |
| | | by Contractor | Processes/Total |
| | | SME having no | Contractor SME Covered |
| | | plans to build | Processes |
| | | Associate SMEs | |
| BACS Process | Number | Identify number | Total Planned BACS |
| Maturity Index | | of Processes | Associate SME Covered |
| | | planned for SME | Processes/Total |
| | | development at | Processes Supported |
| | | SACS for the | from BACS |
| | | processes | |
| | | supported at | |
| | | BACS | |
| Schedule | % | Track SME | Completed Milestones/ |
| Adherence | | development plan | Planned Milestones |
| | | against planned | |
| | | milestones | |

Different metrics for staffing coverage may be determined. Table 1 includes SME demand coverage 1601 and associate SME coverage 1602 for LOB segment 1603, where corresponding status indicators 1613 and 1614 are shown respectively. Status indicator 1620 and status indicator 1613 may indicate the same status when SME demand coverage metric 1601 serves as a key measurement at all levels including line of business, segment, portfolio, and application levels. Since, screenshot 1600 displays both metrics SME demand coverage 1601 and associate SME coverage 1602, it may be important to flag the overall status of the area 1620 for a quick preview.

Status indicators 1613 and 1614 may be color coded to facilitate monitoring by the user. For example, green signifies coverage that is at least 85%, yellow signifies coverage between 60% and 85%, and red signifies coverage less than 60%. The thresholds referenced in this example (60% and 85%) may be configured at the LOB level and its implementation is controlled by the system administrator of the application.

Pie charts 1616 and 1617 show the SME demand coverage and the associate SME coverage, respectively, in a graphical format. Pyramids 1618 and 1618 show workers that are staffing LOB segment 1603 spanning different skill levels, including expert (SME), specialist, and generalist levels. As previously discussed, a worker typically spans multiple components (e.g. sub-modules, modules, and applications). Portfolios 1604 and 1605 are associated with LOB segment 1603, where metrics 1606-1609 are shown for each. With some embodiments, status indicators 1621 and 1622 correspond to SME demand coverage 1606.

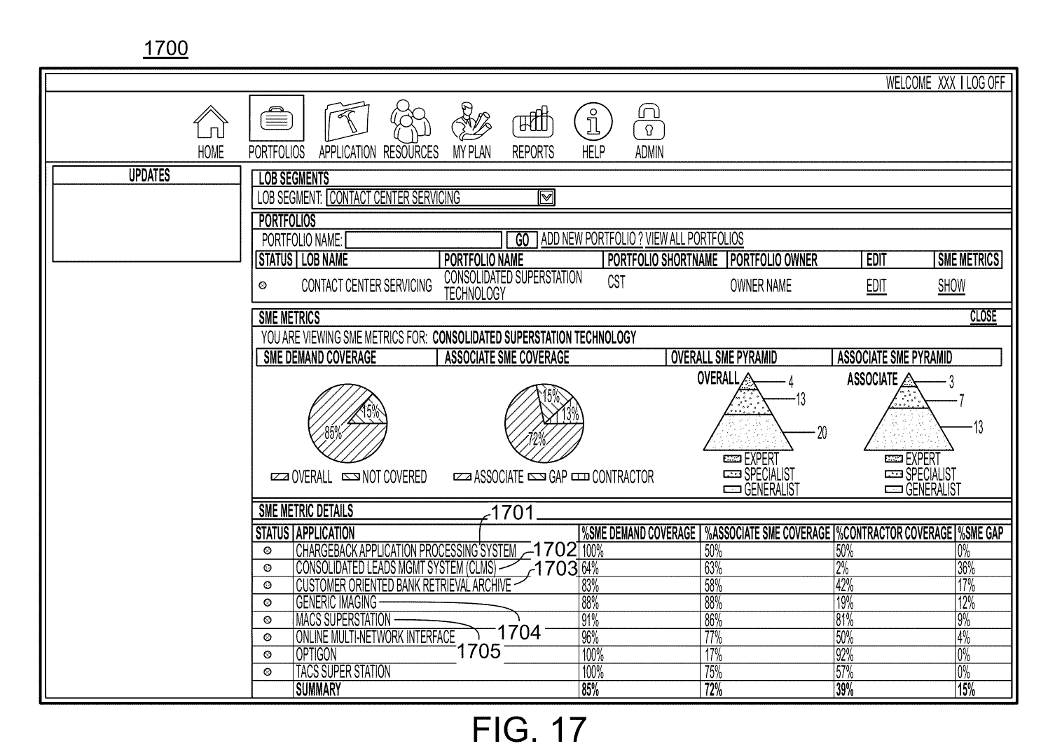

FIG. 17 shows illustrative screenshot 1700 depicting SME staffing for a LOB segment (contact center servicing) in accordance with an aspect of the embodiments. Screenshot 1700 enables the user to drill down to the application level, shown as applications 1701-1705.

The user may manage authorized portfolios in screenshot 1700 and view the SME metrics and pyramid in an extended view.

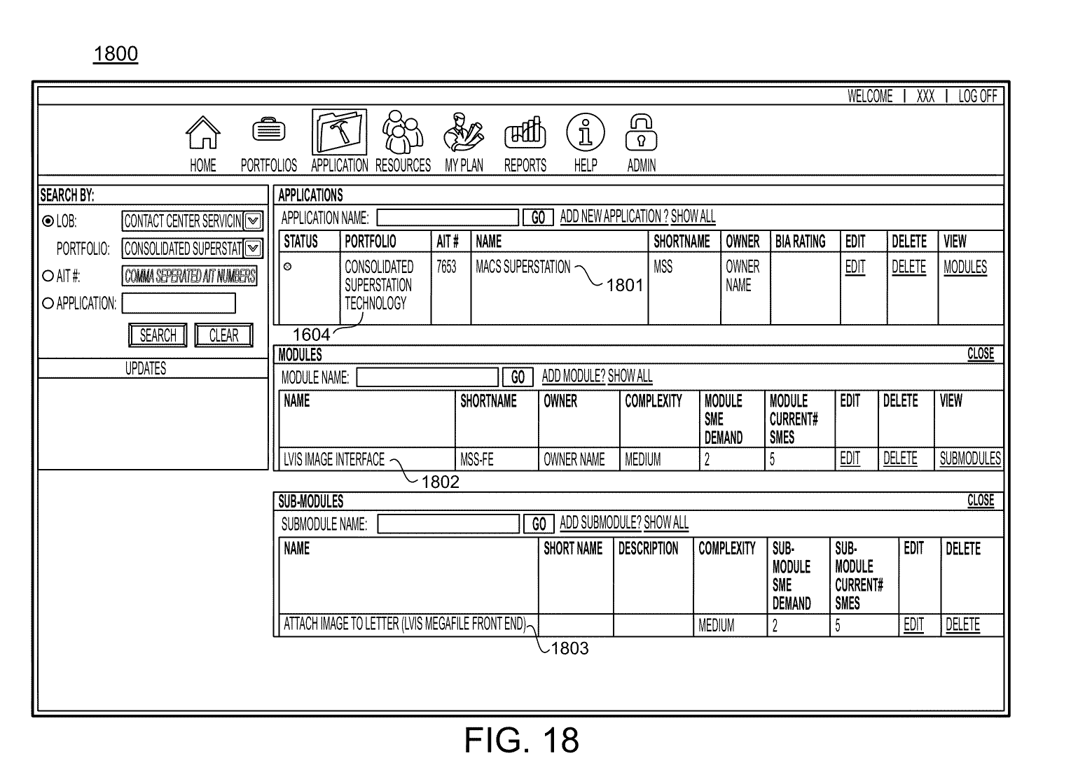

FIG. 18 shows illustrative screenshot 1800 depicting SME staffing for different levels of an application in accordance with an aspect of the embodiments. Screenshot 1800 shows SME demand for sub-module 1803 for module 1802, which is associated with application 1801.

FIG. 19 shows block diagram of system 1900 that assesses SME staffing in accordance with an aspect of the embodiments. A user interacts with the system through user interface 1901. For example, the user may provide SME staffing information and may drill down into staffing assessment (e.g., screenshots 1600-1800) through user interface 1901. Business layer 1951 may encapsulate all the business rules associated with an embodiment. Service layer 1952 (Service Oriented Architecture, SOA) may provide a loosely-integrated suite of services that can be used within multiple systems having similar requirements. Business layer 1951 and service layer 1952 may allow the same business function to be accessed from any part of the user interface (UI) and consequently improve the quality of future maintenance and enhancements.

A user can manage authorized applications and modules/sub-modules associated with the applications from screenshot 1800. The user can also define/change the SME demand of modules and sub-modules through screenshot 1800.

Staffing information and corresponding staffing metrics may be stored in database 1906. Reports 1908 (e.g., screenshots 1600-1800 as previously discussed) may be built from the retrieved data from database 1906 through dispatcher 1907.

Dispatcher 1907 starts services configured and enabled on a computer and routes requests and may comprise a multithreaded application that uses one or more threads per request. Dispatcher 1907 may route requests to such services as: report service, presentation service, job service, monitor service and may also route requests to a specific dispatcher to run a given request. Requests may be routed to specific dispatchers based on load-balancing needs or package requirements.

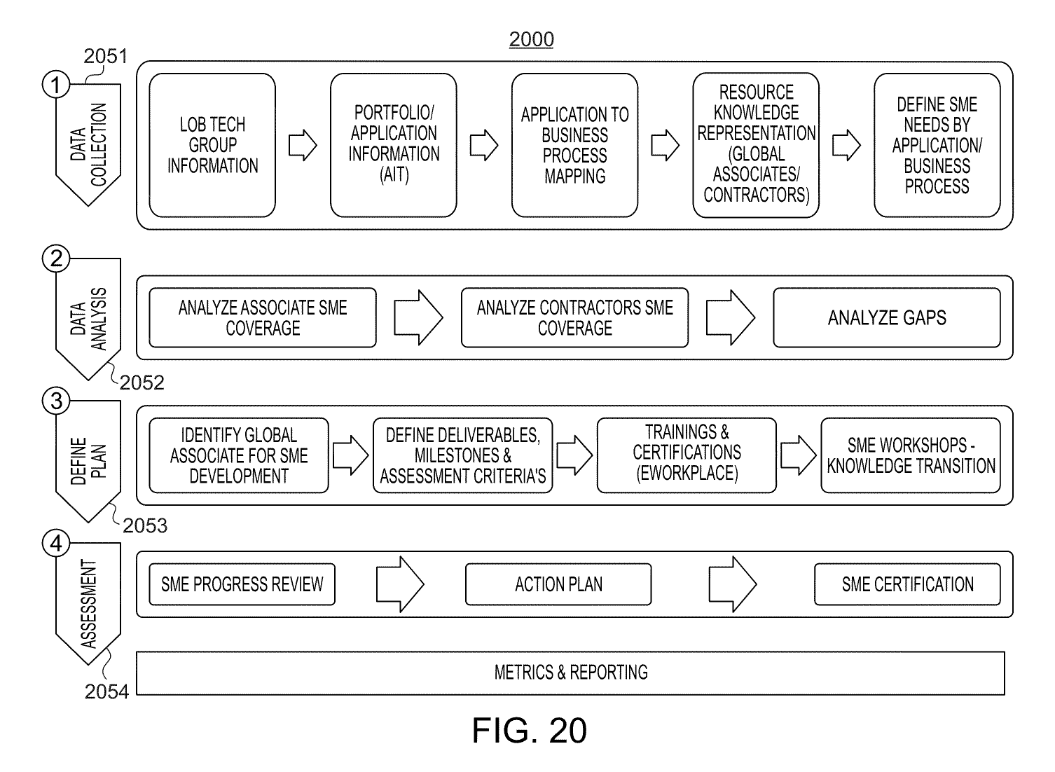

FIG. 20 shows process 2000 that assesses SME staffing and that may be executed by system 1900 in accordance with an aspect of the embodiments. Process layer 2051 (data collection) maps business processes to applications to determine the structure of the applications. For example, modules and sub-modules may be associated with the applications. Also, SME needs are also specified for components of the applications.

Process layer 2052 (data analysis) analyzes associate SME coverage, contractors SME coverage, and staffing gaps as previously discussed. Process layer 2052 may compare the associate coverage with a first predetermined threshold. A first indicator may be generated when training of additional associates is needed. Also, layer 2052 may compare the contractor coverage with a second predetermined threshold and generate a second indicator when redeployment of assigned contractors is needed if the business is overly dependent on contractors, in which the co-employment risk exceeds an acceptable level.

Process layer 2053 (define plan) defines for SME development and defines deliverables, milestones, and criteria for staffing assessment. Once a SME gap is identified through data analysis process layer 2052, the next step may be to fill the gap by developing experts (SMEs). Process layer 2053 outlines steps involved in planning SME development which includes (a) identification of the associates, (b) for each associate, define deliverables, milestones, and measurement criteria to assess the progress (c) define and track training and certifications required to mature to “expert” role, and (d) define specific knowledge sharing work-shops that need be conducted to assist in developing “expert” level knowledge.

Process layer 2054 (assessment) reviews SME progress, an action plan and SME certification. Once a plan is defined for a resource, as shown in process layer 2053, an application owner at periodic intervals may review and assess the progress made against defined milestones. If an associate successfully meets all milestones deliverables, trainings, certifications and workshops, an application manager may then certify the associate as “expert” (SME). For any incompletion or deviations identified against the plan, an application owner may define action plans for next review.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer system comprising:
a first apparatus comprising:
a first memory device; and
a first processor coupled to the first memory device and configured to perform, based on instructions stored in the first memory device:
determining a structure of a software application, wherein the structure comprises a plurality of software application levels;
obtaining staffing information about subject matter experts assigned to the software application based on the structure of the software application;
determining whether there is a staffing gap for the software application from a staffing demand and a staffing coverage at each of the software application levels, wherein:
an associate is an employee of the business;
a contractor works for the business in accordance with a contract; and
the staffing coverage includes an associate coverage and a contractor coverage for the software application; and
distinguishing between the associate coverage and the contractor coverage to determine whether dependence on contractors by the business for the software application exceeds a predetermined acceptable threshold level; and
a second apparatus comprising:
a second memory device; and
a second processor coupled to the second memory device and configured to perform, based on instructions stored in the second memory device:
in response to the distinguishing, supporting maintenance of the software application with the dependence being below the predetermined acceptable threshold level.

2. The computer system of claim 1, wherein the second processor is further configured to perform:
executing the maintained software application.

3. A computer-assisted method comprising:
determining, by a processing device, a structure of a software application, wherein the structure comprises a plurality of software application levels;
obtaining, by the processing device through a communications interface, staffing information of a business for the software application based on the structure of the software application;
determining, by the processing device, a staffing coverage and a staffing demand for each of the software application levels, wherein:
an associate is an employee of the business;
a contractor works for the business in accordance with a contract; and
the staffing coverage includes an associate coverage and contractor coverage for the software application;
determining whether dependence on contractors by the business for the software application exceeds an acceptable level based on the associate coverage and the contractor coverage; and
assessing, by the processing device, a staffing gap for the application from the staffing demand and the staffing coverage at said each of the software application levels.

4. The method of claim 3, wherein the staffing information is indicative of subject matter experts assigned to the software application.

5. The method of claim 3, wherein the structure comprises an intermediary level and a basic level.

6. The method of claim 3, wherein the determining the structure comprises:
mapping a plurality of modules with the software application, wherein the plurality of modules corresponds to the intermediary level; and
mapping a plurality of sub-modules associated with the software application, wherein the plurality of sub-modules corresponds to the basic level and wherein each sub-module is associated with one of the plurality of modules.

7. The method of claim 3, further comprising:
differentiating whether each of the subject matter experts is a business associate.

8. The method of claim 3, further comprising:
comparing the associate coverage with a first predetermined threshold; and
generating a first indicator based on the comparing, the first indicator indicative when training of additional associates are needed.

9. The method of claim 3, further comprising:
comparing the contractor coverage with a second predetermined threshold; and
generating a second indicator based on the comparing, the second indicator indicative when redeployment of assigned contractors are needed.

10. The method of claim 3, wherein the software application is associated with a portfolio, the method further comprising:
repeating the obtaining for another software application, wherein the other software application is associated with the portfolio; and
assessing staffing coverage for the portfolio.

11. The method of claim 10, wherein the portfolio is associated with a business segment, the method further comprising:
repeating the obtaining for another portfolio, wherein the other portfolio is associated with the business segment; and
assessing the staffing coverage for the business segment.

12. An apparatus comprising:
at least one memory; and
at least one processor coupled to the at least one memory and configured to perform, based on instructions stored in the at least one memory:
determining a structure of a software application, wherein the structure comprises a plurality of software application levels;
obtaining staffing information about subject matter experts assigned to the software application based on the structure of the software application;
determining whether there is a staffing gap for the software application from a staffing demand and a staffing coverage at each of the software application levels, wherein:
an associate is an employee of the business;
a contractor works for the business in accordance with a contract; and
the staffing coverage includes an associate coverage and a contractor coverage for the software application; and
distinguishing between the associate coverage and the contractor coverage to determine whether dependence on contractors by the business for the software application exceeds an acceptable level.

13. The apparatus of claim 12, wherein the at least one processor is further configured to perform:
mapping a plurality of modules with the software application.

14. The apparatus of claim 13, wherein the at least one processor is further configured to perform:
mapping a plurality of sub-modules with the software application, wherein each sub-module is associated with one of the plurality of modules.

15. The apparatus of claim 12, wherein the at least one processor is further configured to perform:
differentiating whether each of the subject matter experts is a business associate.

16. A non-transitory computer-readable storage medium storing computer-executable instructions that, when executed, cause a processor to perform operations comprising:
determining a structure of a software application, wherein the structure comprises a plurality of software application levels;
obtaining staffing information about subject matter experts for the software application based on the structure of the software application;
determining a staffing demand and a staffing coverage for each of the software application levels, wherein:
an associate is an employee of the business;
a contractor works for the business in accordance with a contract; and
the staffing coverage includes an associate coverage and a contractor coverage for the software application;
determining whether dependence on contractors by the business for the software application exceeds an acceptable level by distinguishing between the associate coverage and the contractor coverage for the software application; and
assessing whether there is a staffing gap for the software application from the staffing demand and the staffing coverage at said each of the software application levels.

17. The computer-readable storage medium of claim 16, wherein the computer-executable instructions, when executed, cause the processor to perform:
mapping a plurality of modules with the software application, wherein the plurality of modules corresponds to the intermediary level.

18. The computer-readable storage medium of claim 17, wherein the computer-executable instructions, when executed, cause the processor to perform:
mapping a plurality of sub-modules with the software application, wherein the plurality of sub-modules corresponds to the basic level and wherein each sub-module is associated with one of the plurality of modules.

19. The computer-readable storage medium of claim 16, wherein the computer-executable instructions, when executed, cause the processor to perform:
differentiating whether each of the subject matter experts is a business associate.

20. The computer-readable storage medium of claim 16, wherein the computer-executable instructions, when executed, cause the processor to perform:
comparing the associate coverage and the contractor coverage with at least one predetermined threshold: and
generating a first indicator and a second indicator based on the comparing, the first indicator indicative when training of additional associates are needed and the second indicator indicative when redeployment of assigned contractors are needed.
